(19) United States
(12) Patent Application Publication
(10) Pub. No.: US 2003/0067416 A1
(43) Pub. Date: Apr. 10, 2003

(54) Computer having plural monitors

(76) Inventor: YongJoon Kim, Ansan-City (KR)

Correspondence Address: DARBY & DARBY P.C., Post Office Box 5257, New York, NY, 10150-5257, US

(21) Appl. No.: 10/243,975

(22) Filed: Sep. 13, 2002

Related U.S. Application Data
(63) Continuation of application No. PCT/KR01/00404, filed on Mar. 15, 2001.

(30) Foreign Application Priority Data
Mar. 15, 2000 (KR) 2000-07297
Jan. 2, 2001 (KR) 2001-00033
Jan. 2, 2001 (KR) 2001-00034
Jan. 29, 2001 (KR) 2001-02051
Jan. 29, 2001 (KR) 2001-02052

(51) Int. Cl. G09G 5/00

(52) U.S. Cl. 345/1.1

(57) ABSTRACT

The present invention relates to a computer having plural monitors which display output information in each different direction. The present invention is charaterized by a computer composed of a body having a board comprising a CPU, a bottom support and at least two LCD monitors which are attached on each different side of the body and display output information of the CPU by connecting to the board through a graphic card. A computer having plural monitors is capable of displaying the same or different information through the monitors and at least two users can view the output information in each different direction and can utilize the computer for form at the same time.

### TECHNICAL FIELD

The present invention relates to a computer having more than two monitors capable of displaying an output information in different directions, and in particular to a computer having plural monitors by which more than two persons view a certain output information of the computer by displaying the same output information or different output information using different monitors.

### BACKGROUND ART

Generally, a computer includes a body in which a central processing unit, a main memory, sub memory, etc. are installed as an electrical device for a certain programming operation, an input device such as a keyboard, etc., an output device such as a monitor and a printer, and a peripheral device. A certain information is received through the input device and is processed based on a certain processing procedure. A result of the process is stored in the memory and is outputted through an output device such as a monitor.

In the conventional computer, one monitor is connected with one body of the computer, and an input and output information such as an information inputted into the computer and an information processed by the central processing unit is viewed by one monitor. Therefore, the output information is viewed by only one person. In addition, only one person does a certain computer work. Therefore, in the case that the conventional computer is used for a ticket sale work in which a certain information of a customer is inputted, and an inputted information of the customer is processed or the conventional computer is used for an officer in a public office or a bank teller, the input and output information is not viewed by the officer or bank teller with the customer. Therefore, a certain input and output information is directly described to the customer and then the inputted information is directly checked by the customer. Therefore, the information processing time is extended, and the reliability of the work is decreased.

In addition, since the conventional computer is constructed so that only one person does a certain computer work, in the case that the conventional computer is used for an office in which a plurality of persons do a certain work, each person must have his own computer. Therefore, the cost required for an office operation is increased, and the space of the office is decreased.

### DISCLOSURE OF THE INVENTION

Accordingly, it is an object of the present invention to provide a computer having plural monitors which overcomes the problems encountered in the conventional art.

It is another object of the present invention to provide a computer having more than two monitors which is capable of displaying a certain output information of a computer in different directions.

To achieve the above objects, there is provided a computer having plural monitors in which more than two LCD monitors are installed in different sides of the body and are integral to the body and are connected based on a graphic card with respect to the central processing unit and display an input and output information of the central processing unit in a computer formed of a polygonal body having a central processing unit, a main memory, etc. and a support for supporting a lower portion of the body, a computer having plural monitors.

### BRIEF DESCRIPTION OF THE DRAWINGS

The present invention will become better understood with reference to the accompanying drawings which are given only by way of illustration and thus are not limitative of the present invention, wherein:

FIG. 1 is a perspective view illustrating a computer having plural monitors according to a first embodiment of the present invention;

FIG. 2 is a side view illustrating a computer having plural monitors according to the present invention;

FIG. 3 is a view illustrating a state of use of a computer having plural monitors according to a second embodiment of the present invention;

FIG. 4 is a disassembled perspective view illustrating a computer having plural monitors according to a second embodiment of the present invention;

FIG. 5 is a right side perspective view illustrating a computer having plural monitors according to a third embodiment of the present invention;

FIG. 6 is a left side perspective view illustrating a computer having plural monitors according to a third embodiment of the present invention;

FIG. 7 is a view illustrating a first state of use of a computer having plural monitors according to a third embodiment of the present invention;

FIG. 8 is a view illustrating a second state of use of a computer having plural monitors according to a third embodiment of the present invention;

FIG. 9 is a rear view illustrating a second LCD monitor fixture of a computer having plural monitors according to a third embodiment of the present invention;

FIG. 10 is a perspective view illustrating a computer having plural monitors according to a fourth embodiment of the present invention; and

FIG. 11 is a through view illustrating an operation state of a sub LCD monitor of plural monitors according to a fourth embodiment of the present invention.

### MODES FOR CARRYING OUT THE PREFERRED EMBODIMENTS

The embodiments of the present invention will be explained with reference to the accompanying drawings.

[First Embodiment]

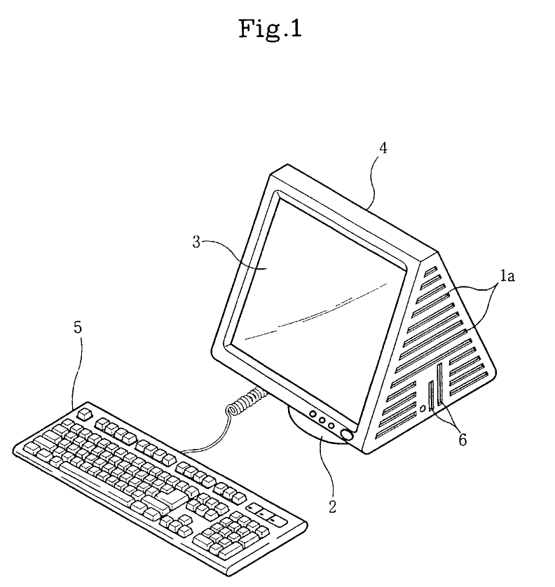

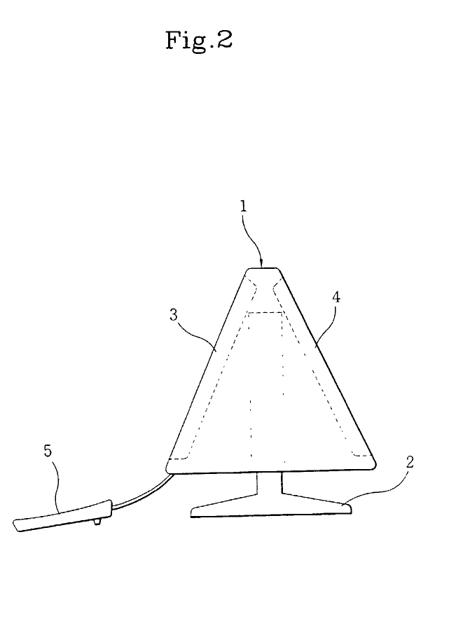

FIG. 1 is a perspective view illustrating a computer having plural monitors according to a first embodiment of the present invention, and FIG. 2 is a side view illustrating a computer having plural monitors according to the present invention;

As shown therein, a computer having plural monitors according to a firs embodiment of the present invention includes a polygonal body 1 including a main board having a central processing unit, etc. and a memory card having a main memory, a support 2 for supporting a lower surface of the body 1 and two LCD monitors 3 and 4 integrally engaged in the front and rear surfaces of the body 1.

The LCD monitors 3 and 4 installed in the front and rear surfaces of the body 1 are installed at a certain angle so that a user easily views the input and output information displayed on the LCD monitors 3 and 4 and are connected based on a graphic card with respect to the central processing unit. Therefore, the input and output information of the central processing unit are displayed thereon.

In the case that the computer having a plurality of monitors according to a first embodiment of the present invention, the LCD monitors 3 and 4 are connected based on one graphic card(not shown) with respect to the central processing unit(not shown), the LCD monitors 3 and 4 display the same information based on the information inputted through one keyboard 5. Therefore, in the thusly constituted computer, two users(for example, two ticket sellers) view and discuss the same output information. In this case, it is not needed to describe the input and output information for thereby significantly decreasing the work process time.

In the computer having a plurality of monitors according to a first embodiment of the present invention, if the LCD monitors 3 and 4 are connected based on a time sharing method using two different graphic cards by connecting the central processing unit, different work environments are implemented on two LCD monitors 3 and 4. Two users share the body 1 and independently do computer work. Therefore, in the case that the present invention is used in an office in which a plurality of workers work, it is possible to significantly increase the space of the office.

In the drawings, reference numeral 1a represents a through hole formed at both sides of the body 1, and reference numeral 6 represents a floppy disk insertion groove and a compact disk insertion groove.

[Second Embodiment]

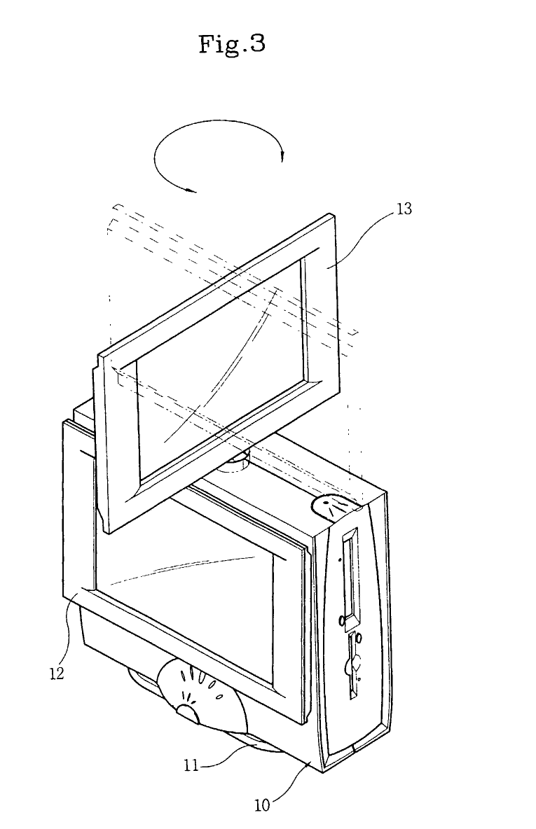

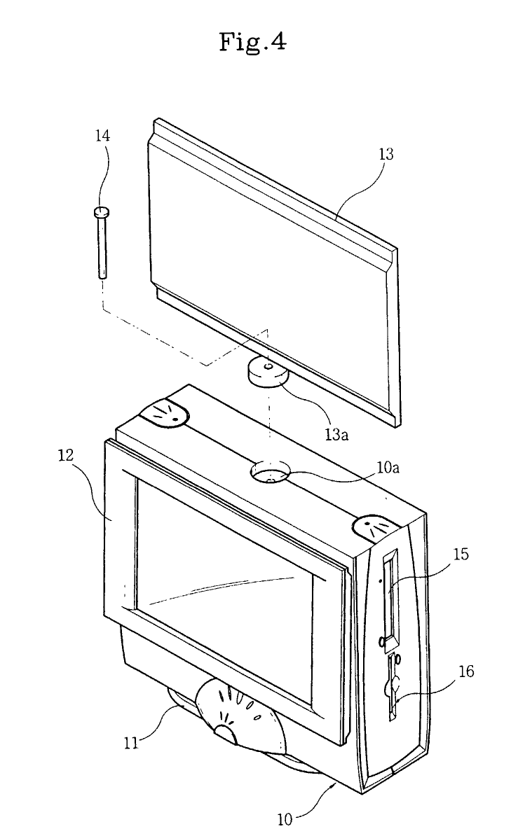

FIG. 3 is a view illustrating a state of use of a computer having plural monitors according to a second embodiment of the present invention, and FIG. 4 is a disassembled perspective view illustrating a computer having plural monitors according to a second embodiment of the present invention.

As shown therein, the computer having plural monitors according to a second embodiment of the present invention, a main user uses the computer and other users view an output information. The computer includes a polygonal body 10 having a main board in which a central processing unit, etc. are installed and a memory card having a main memory, a support 11 for supporting a lower surface of the body 10, a first LCD monitor 2 engaged to a front surface of the body 10 and a second LCD monitor 13 engaged in an upper surface of the body 10 in such a manner that the second LCD monitor 13 is rotatable in a left and right directions.

The LCD monitors 12 and 13 are connected based on a graphic card(not shown) with respect to the central processing unit(not shown) for thereby displaying an output information based on an information inputted through a keyboard(not shown). At this time, the LCD monitors 12 and 13 are capable of displaying different information based on a certain software.

The first LCD monitor 12 displays a main screen, so that a computer user views an output information and is installed in a front surface of the body 10. Preferably, the upper portion of the first LCD monitor 12 is hinged at an upper portion of the front surface of the body 10 in such a manner that an installation angle of the first LCD monitor 12 is adjustable based on a height of a user's eye.

The second LCD monitor 13 displays the same screen as the first LCD monitor or displays a sub screen of the first LCD monitor, so that other persons view the information. In this case, a cylindrical fixture 13a installed at a lower portion of the same is inserted into a fixing groove 10a formed in an upper surface of the body 10 and is rotatably fixed by a fixing pin 14 in such a manner that the LCD monitor is rotatable with respect to the body 10 preferably at an angle of 180°. The second LCD monitor 13 are capable of displaying the same information as the first LCD monitor 12 and selectively displaying a certain information of the output information of the first LCD monitor 12.

In the case that the above computer is used in a place in which two persons(for example, one person is ticket seller, and the other is ticker buyer) share the same output information and discuss, it is not needed to describe the input and output information. Therefore, the work time is significantly decreased.

In the case that the above computer is used in a bank in such a manner that a news and ad are displayed on the second LCD monitor 13, a certain news and ad are displayed on the second LCD monitor 12 while the bank teller does work.

In the drawings, reference numerals 15 and 16 represent a compact disk insertion groove and a floppy disk insertion groove installed in a side surface of the body 10.

[Third Embodiment]

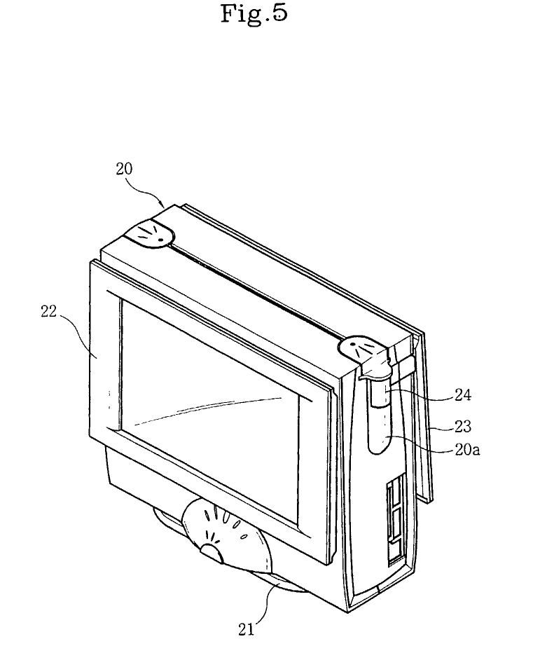

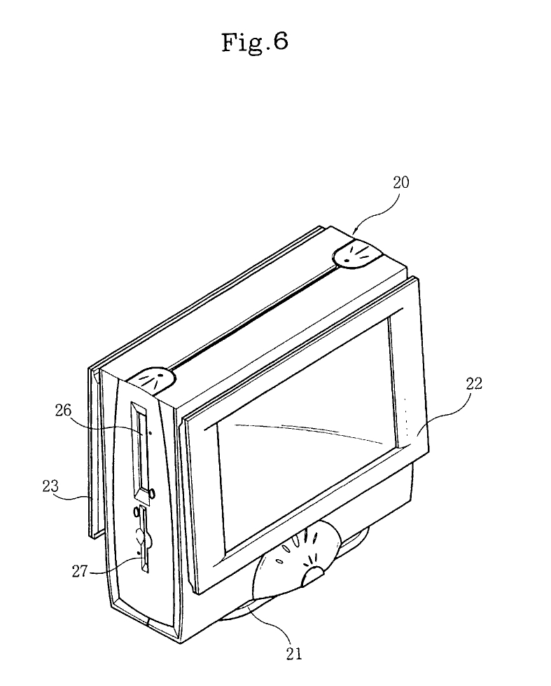

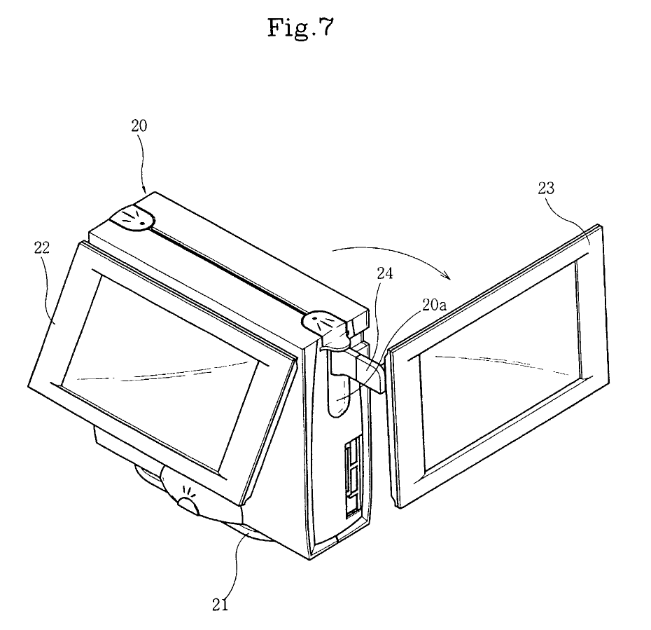

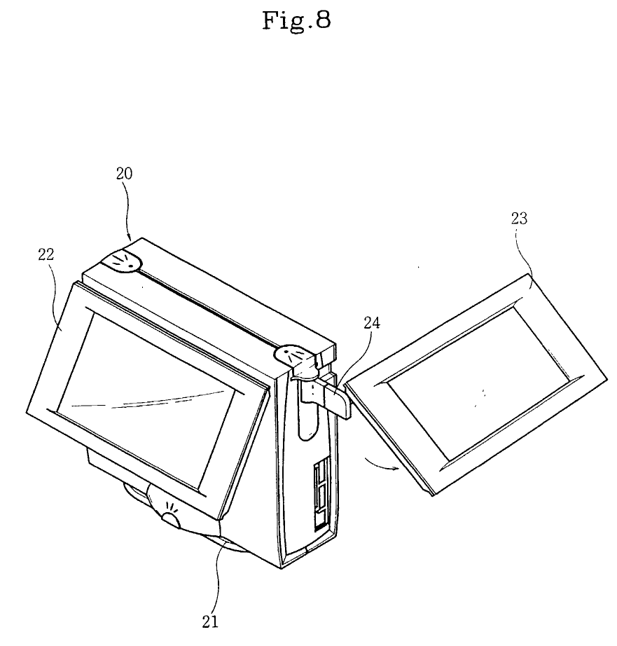

FIG. 5 is a right side perspective view illustrating a computer having plural monitors according to a third embodiment of the present invention, FIG. 6 is a left side perspective view illustrating a computer having plural monitors according to a third embodiment of the present invention, FIG. 7 is a view illustrating a first state of use of a computer having plural monitors according to a third embodiment of the present invention, and FIG. 8 is a view illustrating a second state of use of a computer having plural monitors according to a third embodiment of the present invention.

As shown therein, the computer having plural monitors according to the present invention is constructed in such a manner that two main users independently do a computer work or a main user uses the computer and other persons view the output information. The above computer includes a polygonal body 20 having a main board in which a central processing unit, etc. are installed and a memory card having a main memory, a support 21 for supporting a lower surface of the body 20, a first LCD monitor 22 engaged in a front surface of the body 20, and a second LCD monitor 23 installed in a right surface of the body 20 in such a manner that the second LCD monitor 23 is rotatable in the left and right and upper and lower directions.

The LCD monitors 22 and 23 are connected based on a graphic card(not shown) with respect to a central processing unit(not shown) and display an output information based on an information inputted through a keyboard(not shown). At this time, the LCD monitors 22 and 23 are constructed based on a software for thereby outputting the same information or different information. In particular, in the case that two main users independently do a computer work, an input device(for example, keyboard) is independently used.

The first LCD monitor 22 outputs a main screen of the computer, so that the main user views an output information and is installed in a front surface of the body 20. Preferably, the upper portion of the first LCD monitor 22 is hinged at a front upper portion of the body 20 for thereby adjusting an installation angle based on a height of a user's eye.

The second LCD monitor 23 is constructed to display the other main screen or the same screen as the first LCD monitor or a sub screen of the same. The second LCD monitor 23 is rotatably hinged at a portion of the body 20 by a horizontal hinge device in a horizontal and vertical direction.

As shown in FIG. 7, the horizontal hinge device includes a fixed plate 24 installed in one side of the second LCD monitor, and a fixing portion 20a for fixing the upper and lower portions of the hinge pin which vertically passes through the fixed plate 24 inserted therein, so that the second LCD monitor 23 is horizontally rotatable in one side of the body 20.

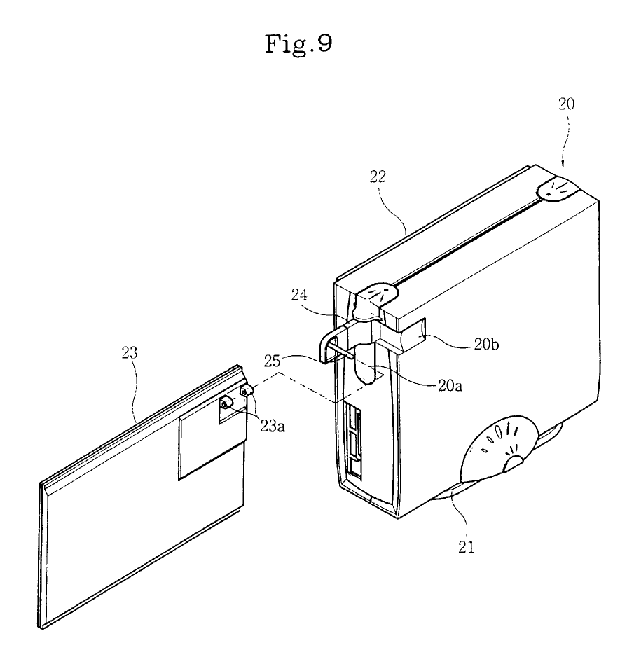

As shown in FIG. 9, the vertical hinge device includes a fixed portion 23a formed in one side of the second LCD monitor 23, and a hinge pin 25 for fixing the fixed portion 23a in a rear surface of the fixed plate 24. Therefore, as shown in FIG. 8, the second LCD monitor 23 is rotatable in the upper and lower directions.

In the computer having plural monitors according to a third embodiment of the present invention, the LCD monitors 22 and 23 are connected with the central processing unit based on an additional graphic card(not shown) for thereby implementing different working environment in each LCD monitor 22 and 23 based on a time sharing method, so that two users share the body 20 and do a computer work. Therefore, the computer according to the third embodiment of the present invention enhances an efficiency of space of the office in which plural persons work.

In addition, two LCD monitors 22 and 23 are connected with the central processing unit using one graphic card. The second LCD monitor 23 displays a sub output information of the first LCD monitor 22. Two users(for example, one is a ticket seller, and the other is a ticket buyer) share the same output information and discuss a certain matter. Therefore, since it is not needed to explain the input and output information to the ticket buyer, it is possible to significantly decrease the work time.

In the drawing, reference numeral 20b represents a receiving groove formed in the rear surface of the body 20 so that the fixed portion 23a and the hinge pin 25 of the vertical hinge device are received therein.

[Fourth Embodiment]

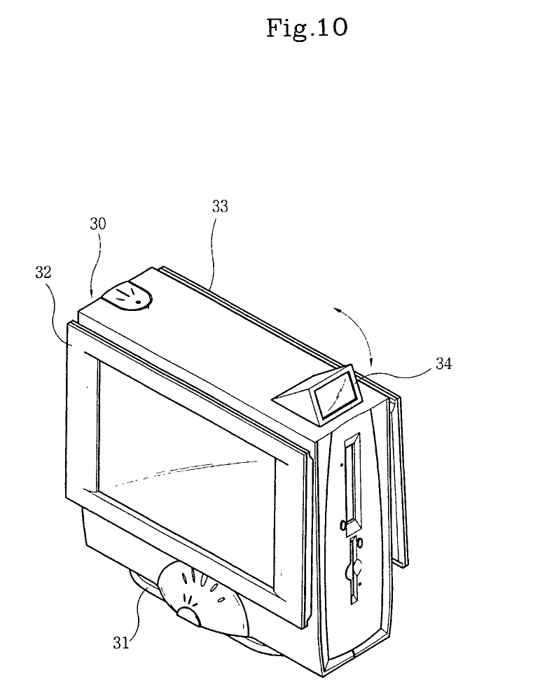

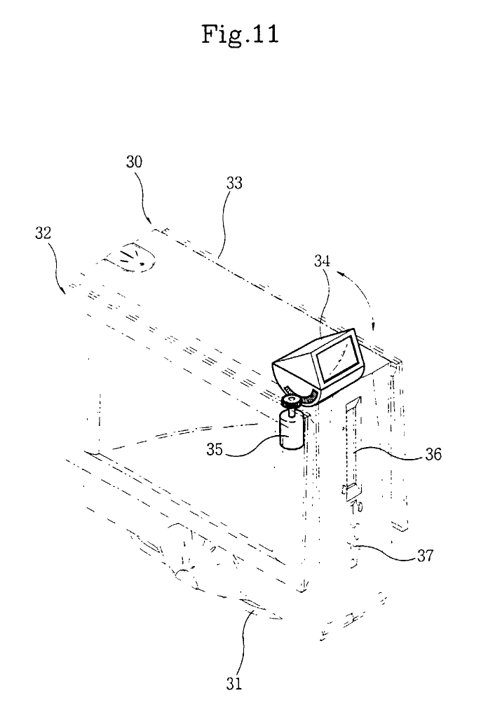

FIG. 10 is a perspective view illustrating a computer having plural monitors according to a fourth embodiment of the present invention, and FIG. 11 is a through view illustrating an operation state of a sub LCD monitor of plural monitors according to a fourth embodiment of the present invention.

As shown therein, the computer having plural monitors according to a fourth embodiment of the present invention includes a body 30, two LCD monitors 32 and 33, and a sub LCD monitor 34 installed in the upper surface of the body 30.

Two LCD monitors 32 and 33 are installed to display different screens in the same manner as the previously described embodiments of the present invention. The sub LCD monitor 34 displays a sub information of the LCD monitors 32 and 33 or displays a certain advertisement.

As shown in FIG. 11, the sub LCD monitor 34 is preferably installed together with an actuator 35 for inputting the sub LCD monitor 34 into the body 30 or exposing the same to the outside based on a driving operation of the power.

According to the fourth embodiment of the present invention, two users view the first and second LCD monitors 32 and 33 which display different output information using one body 30. In addition, a sub information of the LCD monitors 32 and 33 or a certain advertisement is displayed on the sub LCD monitor 34, so that a customer directly view an output information in various ticket sale sites or a certain news or product information is provided to the customer.

In the drawings, reference numerals 36 and 37 represent a compact disk insertion groove and a floppy disk insertion groove installed in side surface of the body 30.

Since the computer having plural monitors according to the present invention displays an output information in different directions, in the case that the present invention is used in various ticket sale sites in which two persons(one person sells the ticket, and the other person buys the ticket) share the same output information and discuss, it is not needed to explain the input and output information, so that it is possible to significantly decrease a processing time of the work.

In addition, each LCD monitor is connected with the central processing unit based on an additional graphic card, and a software is formed in such a manner that different working environments are formed in each LCD monitor, so that two persons share one body and independently do a computer work for thereby significantly increasing the efficiency of the space of the office.

Furthermore, one LCD monitor is constructed to display an independent display and is used in a bank and a ticket sale site, so that it is possible to provide a certain news or various product information to a customer who waits his turn.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a computer formed of a polygonal body having a central processing unit, a main memory, etc. and a support for supporting a lower portion of the body, a computer having plural monitors in which more than two LCD monitors are installed in different sides of the body and are integral to the body and are connected based on a graphic card with respect to the central processing unit and display an input and output information of the central processing unit.

2. The computer of claim 1, wherein said LCD monitors are engaged to the front and rear surfaces of the body and are integral to the body.

3. The computer of either claim 1 or claim 2, wherein said LCD monitors are connected with a central processing unit based on different graphic cards for thereby displaying different input and output information.

4. In a computer formed of a polygonal body having a central processing unit, a main memory, etc. and a support for supporting a lower portion of the body, a computer having plural monitors, comprising:
a first LCD monitor engaged to a front surface of the body and being integral to the body and connected based on a graphic card with respect to the central processing unit for thereby displaying an input and output information of the central processing unit; and
a second LCD monitor connected based on a graphic card with respect to the central processing unit for thereby displaying an input and output information of the central processing unit in such a manner that the second LCD monitor is installed in an upper surface of the body in a vertical direction, and the lower portion of the same is rotatably hinged by a horizontal hinge member with respect to the body in a left and right directions.

5. The computer of claim 4, wherein said first and second LCD monitors are connected with a central processing unit based on different graphic cards for thereby displaying different input and output information.

6. The computer of either claim 4 or claim 5, wherein said first LCD monitor includes an upper portion hinged at a front upper portion of the body for thereby adjusting an installation angle.

7. The computer of claim 4, further comprising a sub LCD monitor installed in an upper surface of the body and connected based on a graphic card with respect to the central processing unit for thereby displaying an input and output information of the central processing unit in a side direction.

8. The computer of claim 7, further comprising an actuator capable of rotating and inputting the sub LCD monitor into the body and exposing the same to the outside.

9. In a computer formed of a polygonal body having a central processing unit, a main memory, etc. and a support for supporting a lower portion of the body, a computer having plural monitors, comprising:
a first LCD monitor installed in a front surface of the body and connected based on a graphic card with respect to the central processing unit for thereby displaying an input and output information of the central processing unit; and
a second LCD monitor connected based on a graphic card with respect to the central processing unit for thereby displaying an input and output information of the central processing unit in such a manner that a portion of the second LCD monitor is hinged at a portion of the body by a horizontal hinge member and is rotatably fixed with respect to the body about the portion in a front and rear directions.

10. The computer of claim 9, wherein said LCD monitors are connected with the central processing unit based on different graphic cards for thereby displaying different input and output information.

11. The computer of either claim 9 or claim 10, further comprising an upper and lower direction hinge member for hinging the second LCD monitor with respect to the horizontal hinge member in the upper and lower directions for thereby implementing a front and rear direction rotation of the second LCD monitor.

12. The computer of either claim 9 or claim 10, wherein said first LCD monitor includes an upper portion hinged to a front upper portion of the body.
